(19) United States
(12) Patent Application Publication
(10) Pub. No.: US 2008/0181704 A1
(43) Pub. Date: Jul. 31, 2008

(54) EXTRACTABLE RIBBON TRAY AND PRINTER UTILIZING THE SAME

(76) Inventor: Cheng-Yuan Yang, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/685,213

(22) Filed: Mar. 13, 2007

(30) Foreign Application Priority Data
Jan. 29, 2007 (TW) 096103227

(51) Int. Cl. B41J 17/32

(52) U.S. Cl. 400/208

(57) ABSTRACT

A ribbon tray. The ribbon tray includes: a body, disposed in a printer in an extractable manner; a bearing component, disposed in the body in a freely detachable manner; and a ribbon, disposed on the bearing component.

### BACKGROUND OF THE INVENTION

1. Field of the Invention

The present invention relates to a ribbon tray, and more particularly, to an extractable ribbon tray and a printer utilizing the same.

2. Description of the Prior Art

Printers are very common electronic products presently. As technology advances, many kinds of printers are invented, from early dot-matrix printers and inkjet printers to recent laser printers and thermal printers. In some types of printers, print heads are utilized to print dyes on a ribbon onto an appropriate medium, thereby achieving the purpose of data printing. In such a case, it is necessary to replace the ribbon with a new one when the dyes thereon are exhausted.

Conventionally, to change a ribbon in a printer, several corresponding covers are required to be opened by users in a preset order before a new ribbon can be inserted therein. In such a case, users should be familiar with correct steps for the preset order and capable of performing the steps to change the ribbon, thereby bringing users certain burdens and inconvenience in practical use. Therefore, it is truly desired to design a new mechanism to change the ribbon in the printer.

### SUMMARY OF THE INVENTION

It is therefore one of the objectives of the present invention to provide an extractable ribbon tray and a printer utilizing the same to solve the above mentioned problems.

According to one embodiment of the present invention, the present invention discloses a ribbon tray, comprising: a body, disposed in a printer in an extractable manner; a bearing component, disposed in the body in a freely detachable manner; and a ribbon, disposed on the bearing component.

According to another embodiment of the present invention, the present invention discloses a printer, comprising: a housing; a ribbon tray, comprising a body, a bearing component, and a ribbon, wherein the body is disposed in the housing in an extractable manner, the bearing component is disposed in the body in a freely detachable manner, and the ribbon is disposed on the bearing component; and a print head, disposed in the housing, for printing a dye on the ribbon onto an appropriate medium.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a three dimensional view illustrating a printer according to an embodiment of the present invention.

FIG. 2 is a three dimensional view illustrating a ribbon tray in FIG. 1.

FIG. 3 is a top view illustrating a ribbon tray in FIG. 2.

FIG. 4 is a left side schematic view illustrating a ribbon tray in FIG. 2.

### DETAILED DESCRIPTION

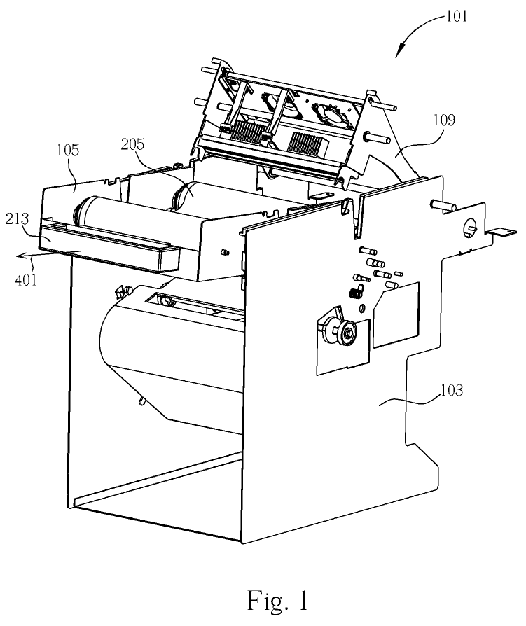

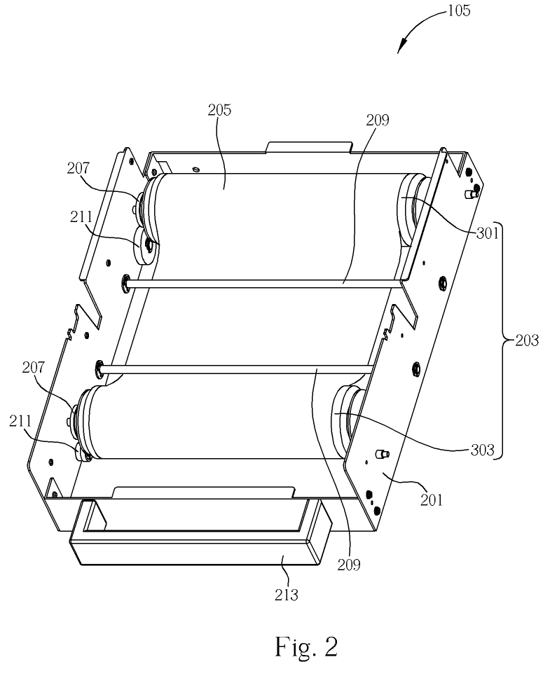

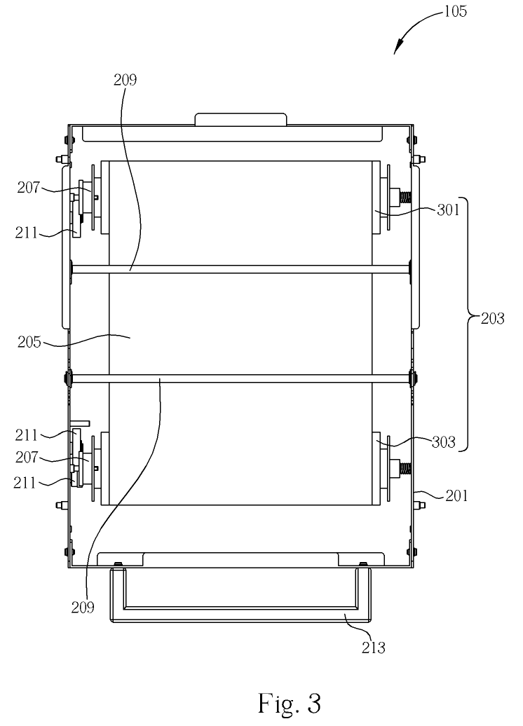

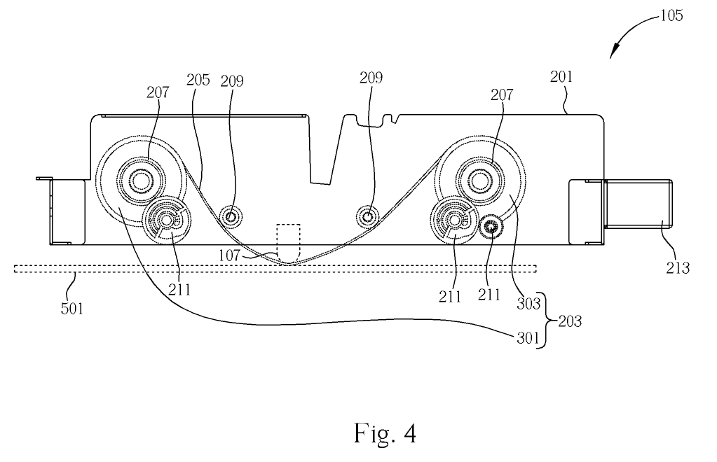

FIG. 1 is a three dimensional view illustrating a printer 101 according to an embodiment of the present invention. FIG. 2 is a three dimensional view illustrating a ribbon tray 105 in FIG. 1. FIG. 3 is a top view illustrating the ribbon tray 105 in FIG. 2. FIG. 4 is a left side schematic view illustrating the ribbon tray 105 in FIG. 2. Additionally, FIG. 4 illustrates how a print head 107 prints a dye on a ribbon 205 onto an appropriate medium 501.

Please refer to FIGS. 1-4 together while reading the following description. As shown, the printer 101 comprises a housing 103, a ribbon tray 105, and a print head 107. The ribbon tray 105 is disposed in the housing 103 in an extractable manner. The print head 107 is disposed in the housing 103. Additionally, in this embodiment, the printer 101 is a thermal dye-sublimation photo printer, and the print head 107 is a thermal print head (TPH). The ribbon 205 in the ribbon tray 105 contains the following dyes thereon: a yellow dye, a magenta dye, and a cyan dye. The appropriate medium 501 is a common A4 paper. This is not meant to be a limitation of the present invention, however.

The ribbon tray 105 comprises a body 201, a bearing component 203, a ribbon 205, a torque limiter (TQL) 207, a guiding component 209, a driving component 211, and a holding component 213. The bearing component 203 comprises a supply spool 301 and a retrieve spool 303. The body 201 of the ribbon tray 105 is disposed in the housing 103 in an extractable manner. The supply spool 301 and the retrieve spool 303 of the bearing component 203 are respectively disposed in the body 201 in a freely detachable manner (e.g. in an engaging manner). Two ends of the ribbon 205 are respectively disposed on the supply spool 301 and the retrieve spool 303 of the bearing component 203. Specifically, in this embodiment, the two ends of the ribbon 205 are respectively wound on the supply spool 301 and the retrieve spool 303 of the bearing component 203. The TQL 207, the guiding component 209, and the driving component 211 are all disposed in the body 201. The holding component 213 is connected to the body 201. Additionally, in this embodiment, there exists one TQL 207 and at least one driving component 211 near the supply spool 301, and so does the retrieve spool 303. Specifically, one TQL 207 is connected between the supply spool 301 and its corresponding driving component 211, and another TQL 207 is connected between the retrieve spool 303 and its corresponding driving component 211. This is not meant to be a limitation to the present invention, however.

Please note that the printer 101 has more components in practice, but only the components related to the present invention are shown in FIGS. 1-4.

To change the ribbon 205 in the ribbon tray 105, a user can extract the ribbon tray 105 from the housing 103 of the printer 101. Specifically, when the holding component 213 receives an appropriate external force 401 applied by the user, the body 201 of the ribbon tray 105 and all components in the body 201 can be extracted out of the housing 103 of the printer 101. Afterwards, the user can detach the supply spool 301, the retrieve spool 303, and the ribbon 205 wound thereon from the body 201 for further replacing the ribbon 205 with a new one.

Besides, to print data, the user can push the ribbon tray 105 into the housing 103 of the printer 101. Meanwhile, a power device (not shown in drawings), such as a motor, in the printer 101 can be connected to the driving component 211, such as a gear train, in the ribbon tray 105 for supplying required power to the driving component 211. Referring to FIG. 4, the driving component 211 can then drive the bearing component 203 to move a portion of the ribbon 205 from the supply spool 301 to the retrieve spool 303. Meanwhile, the guiding component 209 can properly guide the ribbon 205, such that a corresponding portion of the ribbon 205 can be smoothly moved from the supply spool 301 to the retrieve spool 303, thereby avoiding ribbon displacement. Moreover, while the ribbon 205 moves, the TQL 207 can keep an operating torque applied on the ribbon 205 at a substantially fixed value. Therefore, the ribbon 205 can be steadily dragged by the operating torque of the substantially fixed value and thus can be stretched properly tight from beginning to end. Accordingly, it is feasible to maintain stable printing quality as the print head 107 prints a dye on the ribbon 205 onto the appropriate medium 501. Additionally, in this embodiment, the driving component 211 drives the TQL 207 for further driving the bearing component 203 substantially. This is not meant to be a limitation of the present invention, however.

Please note that although the ribbon tray 105 is placed into the printer 101 from the front of the printer 101 in FIG. 1, this is not meant to be a limitation of the present invention. Furthermore, provided the principles as disclosed in the present invention are achieved, the ribbon tray 105 can be placed into the housing 103 of the printer 101 from the side of the printer 101, from the back of the printer 101, or in any other possible manner.

Please note that although an upper cover 109 of the housing 103 is upraised as the user extracts or pushes the ribbon tray 105 in FIG. 1, this is not meant to be a limitation of the present invention. Furthermore, provided the principles as disclosed in the present invention are achieved, the upper cover 109 of the housing 103 can be properly designed such that the user can directly extract or push the ribbon tray 105 without upraising the upper cover 109, moving, or opening any component of the housing 103 in advance.

Please note that, in the present invention, the user can extract the whole of the ribbon tray 105 out of the housing 103 of the printer 101, and thus the ribbon tray 105 is completely separated from the housing 103. This is not meant to be a limitation of the present invention, however. Furthermore, provided the principles as disclosed in the present invention are achieved, the user can also extract the ribbon tray 105 from the housing 103 of the printer 101 for an appropriate distance sufficient for the user to change the ribbon 205.

In one embodiment of the present invention, using an extractable ribbon tray as disclosed above, a user can directly extract the ribbon tray from a housing of a printer completely or for an appropriate distance by a holding component (e.g. handle) of the ribbon tray for changing a ribbon in the ribbon tray without moving or opening any component of the housing of the printer in advance, thereby greatly improving convenience in practical use. Additionally, since the ribbon tray of the present invention can be completely extracted out of the housing of the printer as described above, the user need not stand near the printer to change the ribbon. Therefore, reserved space between the printer of the present invention and its surrounding items required for the ribbon changing operation can be greatly reduced, thereby achieving the effect of saving space.

Those skilled in the art will readily observe that numerous modifications and alterations of the device and method may be made while retaining the teachings of the invention.

What is claimed is:

1. A ribbon tray, comprising:
a body, disposed in a printer in an extractable manner;
a bearing component, disposed in the body in a freely detachable manner; and
a ribbon, disposed on the bearing component.

2. The ribbon tray of claim 1, wherein the bearing component comprises a supply spool and a retrieve spool respectively disposed in the body in a freely detachable manner, and two ends of the ribbon are respectively disposed on the supply spool and the retrieve spool.

3. The ribbon tray of claim 2, further comprising:
a driving component, disposed in the body for driving the bearing component to move a portion of the ribbon from the supply spool to the retrieve spool.

4. The ribbon tray of claim 3, further comprising:
a guiding component, disposed in the body for guiding a corresponding portion of the ribbon to move from the supply spool to the retrieve spool when the driving component drives the bearing component.

5. The ribbon tray of claim 1, further comprising:
a torque limiter (TQL), disposed in the body for keeping an operating torque applied on the ribbon at a substantially fixed value.

6. The ribbon tray of claim 1, further comprising:
a holding component, connected to the body for receiving an appropriate external force to extract the body out of the printer.

7. The ribbon tray of claim 1, wherein the ribbon is wound on the bearing component.

8. A printer, comprising:
a housing;
a ribbon tray, comprising a body, a bearing component, and a ribbon, wherein the body is disposed in the housing in an extractable manner, the bearing component is disposed in the body in a freely detachable manner, and the ribbon is disposed on the bearing component; and
a print head, disposed in the housing, for printing a dye on the ribbon onto an appropriate medium.

9. The printer of claim 8, wherein the bearing component comprises a supply spool and a retrieve spool respectively disposed in the body in a freely detachable manner, and two ends of the ribbon are respectively disposed on the supply spool and the retrieve spool.

10. The printer of claim 9, wherein the ribbon tray further comprises:
a driving component, disposed in the body for driving the bearing component to move a portion of the ribbon from the supply spool to the retrieve spool.

11. The printer of claim 10, wherein the ribbon tray further comprises:
a guiding component, disposed in the body for guiding a corresponding portion of the ribbon to move from the supply spool to the retrieve spool when the driving component drives the bearing component.

12. The printer of claim 8, wherein the ribbon tray further comprises:
a TQL, disposed in the body for keeping an operating torque applied on the ribbon at a substantially fixed value.

13. The printer of claim 8, wherein the ribbon tray further comprises:
a holding component, connected to the body for receiving an appropriate external force to extract the body out of the printer.

14. The printer of claim 8, wherein the ribbon is wound on the bearing component.

15. The printer of claim 8, wherein the printer is a thermal dye-sublimation photo printer, and the print head is a thermal print head (TPH).
